(19) United States
(12) Patent Application Publication
(10) Pub. No.: US 2025/0003830 A1
(43) Pub. Date: Jan. 2, 2025

(54) METHOD FOR MONITORING THE STATE OF A MACHINE, SYSTEM, COMPUTER PROGRAM

(71) Applicant: Schaeffler Technologies AG & Co. KG, Herzogenaurach (DE)

(72) Inventors: Jukka Elfström, Jyväskylä (FI); Sami Moisio, Tampere (FI); Andreas Kühl, Herzogenrath (DE)

(21) Appl. No.: 18/709,781

(22) PCT Filed: Nov. 2, 2022
(86) PCT No.: PCT/DE2022/100805

§ 371 Date: May 13, 2024

(30) Foreign Application Priority Data
Nov. 11, 2021 (DE) 10 2021 129 363.4

(51) Int. Cl. G01M 7/02

(52) U.S. Cl. CPC G01M 7/025

(57) ABSTRACT

The invention relates to a method for monitoring the state of a machine, the machine comprising a sensor system, the sensor system comprising a vibration and/or temperature sensor for measuring a vibration and/or a temperature of the machine as well as a trigger sensor, the sensor system being operable in a learning mode and a state monitoring mode.

### CROSS-REFERENCE TO RELATED APPLICATION

The present application is the U.S. National Phase of PCT Patent Application Number PCT/DE2022/100805, filed on Nov. 2, 2022, which claims priority to German Patent Application Number 10 2021 129 363.4, filed Nov. 11, 2021, the entire disclosures of which are incorporated by reference herein.

### TECHNICAL FIELD

The disclosure relates to a method for the condition monitoring of a machine. The disclosure also relates to a corresponding system and computer program.

### BACKGROUND

Sensors with cables are usually used for vibration-based condition monitoring or temperature-based condition monitoring, which generally results in expensive systems and methods. One of the main reasons for this is that the manual installation of such sensors, including the installation and protection of the cables, is time-consuming. A more cost-effective condition monitoring can be realized by using wireless vibration-based or temperature-based condition monitoring systems. Such systems, in particular the sensors, are usually battery-powered. The typical battery life of wireless battery-powered vibration sensors, for example, is around five years.

In such conventional systems, the battery-powered wireless vibration sensors measure the data according to a schedule. For example, KPIs (Key Performance Indicators), such as the ISO vibration severity 10-1000 Hz RMS, are measured every 4 hours and raw data every 24 hours. However, such measurements carried out according to a fixed schedule can result in insufficient data quality and a detrimental condition monitoring for a variety of different machines and applications, such as machines not operating continuously or machines with different operating states or modes or conditions, as the measurement data is often obtained when the machine is not running or is in a mode that is not suitable for condition monitoring.

DE 10 2018 221 585 A1 describes a method for processing measurement and operating data of a machine component with at least one measuring component, comprising the method steps of receiving operating data provided by the machine component, recognizing an operating state of the machine component on the basis of the operating data and determining whether the operating state is suitable for carrying out a measurement, triggering a measurement by the measuring component in the event that an operating state is suitable for the measurement, receiving measurement data of the measuring component generated on the basis of the measurement, combining at least the measurement data and the operating data to form a data set, and providing the data set.

DE 10 2007 039 699 A1 describes a method for monitoring a device, wherein a frequency band-related sound monitoring is carried out at measurement positions depending on the operating point of the device. The operating point lies in a one- or multi-dimensional associated operating space, which is spanned by the condition variables assigned to the device.

### SUMMARY

Against this background, the object of the disclosure is to provide an improved and/or more energy-efficient condition monitoring of a machine, in particular such that an improved condition monitoring can be achieved for machines not operating continuously or machines with different operating states or modes or conditions.

To achieve this object, the disclosure proposes a method for the condition monitoring of a machine,
wherein the machine comprises a sensor system, wherein the sensor system comprises:
   a vibration and/or temperature sensor for measuring a machine vibration and/or a temperature of the machine, and
   a trigger sensor;
wherein the sensor system can be operated in a learning mode and in a condition monitoring mode,
wherein the method comprises the following steps:
a) operating the sensor system in the learning mode in order to determine a trigger threshold for the trigger sensor,
b) operating the sensor system in the condition monitoring mode, wherein operating the sensor in the condition monitoring mode comprises the following steps:
   in a trigger step, the trigger sensor measures a machine signal of the machine,
   wherein a comparison between the machine signal and the trigger threshold is carried out,
   wherein, depending on the comparison between the machine signal and the trigger threshold, the vibration and/or temperature sensor is transferred to a measuring state for carrying out a measuring step,
   in the measuring step, the vibration and/or temperature sensor measures a machine vibration and/or temperature signal of the machine in order to determine the condition of the machine.

According to the disclosure, it is possible for the measuring step to be carried out in the condition monitoring mode of the sensor system depending on the machine signal (obtained by the trigger sensor) and a previously determined trigger threshold. The trigger threshold is advantageously determined by a learning phase of the sensor system carried out in step a). In this regard, it is possible to advantageously adapt the trigger threshold to the respective sensor system and the respective machine as well as to the environmental influences and noises to which the sensor system is exposed in its application. By using the trigger threshold according to the disclosure, the data quality of the machine vibration and/or temperature signal for condition monitoring can be improved, since the amount of data measured at times when the machine is not operating or not operating in a useful state for condition monitoring can be advantageously reduced. This advantageously allows data to be collected from valid machine conditions while minimizing the collection of data points outside of those conditions. At the same time, the total energy consumption for the condition monitoring can be reduced so that the battery life of the sensors is extended or the energy harvesting power is sufficient for the operation of the sensors. In general, the present disclosure makes it possible to minimize the processing and transmission of unnecessary data, thereby reducing costs and saving energy.

By means of the present disclosure, the advance warning time before a machine fails can be increased by using the trigger threshold according to the disclosure. In particular, by using the trigger threshold according to the disclosure, which is determined by means of step a), it is advantageously possible to improve the data quality and thus the condition monitoring compared to the use of a preconfigured (possibly machine-specific) value for the trigger threshold in the condition monitoring mode of the sensor system. Such a preconfigured trigger threshold would not be able to take into account the specific conditions, noise and environmental influences to which the machine and the sensor system are exposed in their use. However, such influences can advantageously be taken into account by the present disclosure and by determining a trigger threshold by means of a learning mode of the sensor system.

Another advantage of the present disclosure is that the improved condition monitoring that can be achieved by the trigger threshold according to the disclosure can be realized in an automated manner, preferably without human interaction or configuration input. This is particularly advantageous for sensor systems that are produced in large quantities. Even if identical sensor systems are used for multiple identical machines, the individual operating conditions and the influences of the environment are typically different for each individual machine and each sensor system. With the aid of the present disclosure, an individually learned trigger threshold can be automatically determined for each individual sensor system and each individual machine, thereby improving the quality of the condition monitoring and keeping costs low.

According to one embodiment of the present disclosure, it is conceivable that step a) is carried out before step b). In particular, it is conceivable that step a) is carried out during the initial installation or initial use of the sensor system and/or the machine.

It is conceivable that the machine vibration and/or temperature signal measured by the vibration and/or temperature sensor consists of a plurality of individual samples. These samples can also be understood as measurement data points and/or values. It is also conceivable that the machine signal measured by the trigger sensor comprises a plurality of individual samples.

According to the disclosure, it is possible that the condition of the machine is determined by means of or based on the machine vibration and/or temperature signal of the machine measured by the vibration and/or temperature sensor, in particular in the condition monitoring mode of the sensor system in step b). Advantageously, the machine signal from the trigger sensor can be used to detect whether the machine is in operation, so that a condition of the machine can be determined. In particular, it is determined in step b) whether the machine is in operation, in particular whether the machine is in an operating state, by comparing the machine signal (from the trigger sensor) with the trigger threshold, so that the condition of the machine can be determined. Preferably, only when it is detected that the machine is in such an operating state, is the vibration and/or temperature sensor triggered in such a way that the vibration and/or temperature sensor is activated and/or transferred to a measuring state for measuring the vibration and/or temperature signal.

It is conceivable that the condition of the machine refers, for example, to whether the machine is defective or shows signs of wear. Such effects can be detected in the vibration and/or temperature signal of the machine or by means of the vibration and/or temperature signal of the machine.

Preferably, it is conceivable that the vibration and/or temperature sensor comprises at least one MEMS (micro-electromechanical system) for measuring a machine vibration signal.

According to the present disclosure, the trigger threshold can be a trigger threshold value.

According to one embodiment, it is preferred that in step b) (i.e., in the condition monitoring mode of the sensor system), depending on the comparison between the machine signal measured by the trigger sensor and the trigger threshold, the vibration and/or temperature sensor is transferred from an off state or idle state to the measuring state, so that a measuring step is carried out by means of the vibration and/or temperature sensor. Preferably, the vibration and/or temperature sensor is deactivated in the off state or idle state of the vibration and/or temperature sensor, so that the vibration and/or temperature sensor does not measure the machine vibration and/or temperature signal of the machine. It is particularly preferred that in the off state or idle state of the vibration and/or temperature sensor, the energy consumption of the vibration and/or temperature sensor is lower than in the measuring state.

According to the present disclosure, it is preferred that the machine is a machine not operating continuously and/or a machine with different operating states or modes or conditions. For example, it is conceivable that the machine comprises or is
a construction machine, in particular a crane,
a mining machine,
an agricultural machine,
a processing machine,
a logistics machine, in particular a storage and retrieval unit,
a transportation machine, in particular a subway or a railroad or a train.

According to one embodiment of the present disclosure, the sensor system can be part of the machine or attached to the machine or to a component of the machine. The exact position of the sensor system may depend on the type of machine.

Preferably, the vibration and/or temperature sensor and the trigger sensor are wireless sensors comprising energy storage and/or energy harvesting devices. For example, it is conceivable that the vibration and/or temperature sensor and/or the trigger sensor comprise one or more batteries. It is conceivable that the trigger sensor is a component or sub-component of the vibration and/or temperature sensor. It is conceivable that the trigger sensor is used and/or operated at least partially independently of the other vibration and/or temperature sensor. However, it is also possible that, according to the present disclosure, the trigger sensor and the vibration and/or temperature sensor are separate sensors.

Preferred embodiments of the present disclosure can be derived from the dependent claims.

According to the disclosure, the sensor system is provided with a predefined further trigger threshold for the trigger sensor, before and/or during operation of the sensor system in the learning mode, wherein operating the sensor system in the learning mode in order to determine a trigger threshold for the trigger sensor comprises the following steps:
in a learning trigger step, the trigger sensor measures a machine signal of the machine,
   wherein a comparison between the machine signal and the further trigger threshold is carried out,
   wherein, depending on the comparison between the machine signal and the further trigger threshold, the vibration and/or temperature sensor transitions to the measuring state for carrying out a learning measuring step,
in the learning measuring step, the vibration and/or temperature sensor measures a machine vibration and/or temperature signal of the machine in order to obtain the learning data,
   wherein—in particular prior to operating the sensor system in the condition monitoring mode—the learning data obtained in the learning mode is used to determine the trigger threshold to be used in the condition monitoring mode of the sensor system, in particular in step b). In this regard, the learning data comprises the machine vibration and/or temperature signal(s) obtained in the learning measuring step. The learning data obtained in this way is particularly suitable for identifying an optimal trigger threshold that leads to particularly advantageous results for the individual sensor system and the machine. In this regard, environmental influences on the sensor system and/or specific properties of the machine can advantageously be taken into account when determining the trigger threshold, which is used later in step b), i.e., in the condition monitoring mode of the sensor system.

It is conceivable that the further trigger threshold provided to the sensor system for carrying out step a) is a predefined value. It is conceivable that this predefined further trigger threshold is machine-specific and/or sensor system-specific. However, this value is typically not able to take into account the specific conditions and noise experienced by the sensor system at the location of the machine. Therefore, an improved and even more suitable trigger threshold is determined in step a).

According to one embodiment of the present disclosure, it is preferred that the learning trigger step and the learning measuring step in step a) are repeated one or more times to obtain a large data set of learning data for determining the trigger threshold.

According to the disclosure, the trigger threshold is used using the learning data obtained in the learning mode and using statistical methods and/or machine learning and/or artificial intelligence.

The trigger threshold can be determined, for example, by means of computing means of a backend system and/or the machine and/or the sensor system and/or a gateway unit. It is possible for the learning data to be transmitted from the sensor system or the machine to the backend system via a communication network. It is conceivable that the backend system determines the trigger threshold and transmits the trigger threshold to the sensor system or the machine. The backend system can be implemented using a cloud, for example. However, it is also conceivable that the determination of the trigger threshold is carried out by means of computing means of the machine and/or the sensor system and/or by means of computing means of a gateway entity located at the location of the machine.

According to a preferred embodiment of the present disclosure
the trigger sensor is designed to measure a machine vibration of the machine, wherein preferably the machine signal measured by the trigger sensor in the trigger step and/or in the learning trigger step is a trigger vibration signal of the machine; and/or
the trigger sensor is designed to measure an electrical signal of the machine, in particular an electrical current and/or an electrical voltage, wherein preferably the machine signal measured by the trigger sensor in the trigger step and/or in the learning trigger step is an electrical signal of the machine.

It is particularly preferred that the trigger sensor is a vibration sensor, in particular a MEMS vibration sensor, which is designed to measure a machine vibration of the machine. It is further preferred that the trigger sensor has a lower sampling rate than the vibration and/or temperature sensor. For example, it is possible that the sampling rate of the trigger sensor is below 100 Hz, preferably at or below 50 Hz, particularly preferably at or below 10 Hz. In this way, the energy consumption can be kept low. It is particularly preferred that the trigger sensor has a lower energy consumption during operation than the vibration and/or temperature sensor. According to an alternative embodiment, it is conceivable, for example, that the trigger sensor is an electrical sensor which is designed to measure an electrical variable, for example a current and/or a voltage, of the machine.

According to one embodiment of the present disclosure in step b), it is conceivable that the trigger sensor is in a trigger state in the trigger step, so that the trigger sensor measures the machine signal of the machine in the trigger state, wherein in a preliminary step, before the trigger step and/or at the beginning of the trigger step, the trigger sensor is transferred to the trigger state in response to the receipt of an external trigger signal. In particular, the trigger sensor transitions from an off state or idle state to the trigger state in response to the receipt of the external trigger signal. This makes it possible to further reduce energy consumption in the condition monitoring mode of the sensor system, as the trigger sensor is not constantly in the trigger state, but can sometimes be in an off state or idle state, in particular at times when no condition monitoring measurements are desired. It is particularly preferred that the energy consumption of the trigger sensor is lower in the off state or in the idle state than in the trigger state. However, according to an alternative embodiment of the present disclosure, it is conceivable that the trigger sensor is continuously operated in the trigger state when the sensor system is in the condition monitoring mode. In this case, too, the energy consumption can be reduced compared to conventional systems known from the prior art, as the trigger sensor has a comparatively low energy consumption in the trigger state, in particular compared to the energy consumption of the vibration and/or temperature sensor in the measuring state.

According to a preferred embodiment of the present disclosure, the external trigger signal is generated by means of a further sensor and/or a computing device when it is determined by the further sensor and/or the computing device that the machine is in an operating state and/or has transitioned to an operating state, wherein preferably the further sensor and/or the computing device are part of the machine and/or are connected to the machine and/or are in communication with the machine. It is conceivable that the external trigger signal is received by the trigger sensor from the further sensor and/or the computing device, in particular directly or via a gateway unit. The computing device can be a microcontroller of the machine or the further sensor. The computing device can be a programmable logic controller (PLC). The computing device can be part of the gateway unit and can generate the external trigger signal in response to the receipt of a trigger from the further sensor or from a telecommunications network. The determination that the machine is in an operating state and/or has transitioned to an operating state can be made, for example, by the further sensor measuring a further sensor signal of the machine, wherein a further comparison between the further sensor signal and a further threshold value is carried out, so that it is determined by means of the further comparison whether the machine is in an operating state and/or has transitioned to an operating state. According to one embodiment of the present disclosure, it is conceivable that the further sensor is a speed sensor and/or a torque sensor. However, according to alternative embodiments of the present disclosure, other sensor types are also possible. Particularly advantageously, it is possible that the further sensor is in operation anyway and/or measures the further sensor signal, for example as part of a functionality of the machine that is not related to condition monitoring or for purposes that are not related to condition monitoring, in particular during operation of the machine.

According to a preferred embodiment of the present disclosure, the vibration and/or temperature sensor and/or the trigger sensor and/or the further sensor are entities of a mesh network, wherein step b) of a method according to an embodiment of the present disclosure (i.e., operating the sensor system in the condition monitoring mode) is carried out only during one or more predefined time intervals, in particular one or more predefined time intervals that repeat at regular or irregular intervals or patterns. Preferably, it is conceivable that—during the one or more predefined time intervals—the mesh network and/or at least the communication means of the entities of the mesh network are activated, wherein preferably—outside of the one or more predefined time intervals—the mesh network and/or the communication means of the entities of the mesh network are partially or completely deactivated. In particular, it is conceivable that the vibration and/or temperature sensor and/or the trigger sensor and/or the further sensor and/or communication means of the vibration and/or temperature sensor and/or communication means of the trigger sensor and/or communication means of the further sensor are activated during the one or more predefined time intervals, wherein preferably outside of the one or more predefined time intervals the vibration and/or temperature sensor and/or the trigger sensor and/or the further sensor and/or communication means of the vibration and/or temperature sensor and/or communication means of the trigger sensor and/or communication means of the further sensor are partially or completely deactivated. In this way, energy consumption can be reduced even further, as the communication means of the various units in the mesh network can account for a significant proportion of the total energy consumption.

According to a preferred embodiment of the present disclosure, it is possible for the vibration and/or temperature sensor and/or the trigger sensor and/or the further sensor to be placed in a deep sleep mode outside of the one or more predefined time intervals, wherein the one or more sensors do not utilize radio capabilities or radio communication capabilities. It is preferred that the sensor or sensors are woken up from the deep sleep mode for the one or more predefined time intervals, for example by a microcontroller unit real-time clock (MCU RTC), for example every day for one hour. It is particularly preferred that all sensors in the mesh network wake up at the same time. In this regard, it is possible for some or all of the sensors to carry out measurements in the one or more predefined time intervals. After the measurements, in particular after the measuring step according to the disclosure, it is preferred that the sensors are put back into the deep sleep mode. This can significantly extend the battery life of the sensors.

According to a preferred embodiment of the present disclosure, before the vibration and/or temperature sensor transitions to the measuring state and/or before the vibration and/or temperature sensor measures the machine vibration and/or temperature signal in the measuring step, a machine stabilization algorithm is carried out, in particular by means of computing means of the trigger sensor and/or computing means of a gateway unit and/or computing means of the machine, wherein the machine stabilization algorithm comprises that:
a waiting time is allowed to elapse before the vibration and/or temperature sensor transitions to the measuring state and/or before the vibration and/or temperature sensor measures the machine vibration and/or temperature signal in the measuring step, and/or
a preliminary analysis is carried out in order to verify or check that the machine is in operation and/or to verify or check that the machine is in an operating state, wherein preferably the vibration and/or temperature sensor transitions to the measuring state and/or starts measuring the machine vibration and/or temperature signal in the measuring step only after the waiting time has elapsed and/or only in the event that the preliminary analysis carried out shows that the machine is in operation and/or in an operating state. The machine stabilization algorithm is preferably carried out in step b) of a method according to an embodiment of the present disclosure, i.e., when the sensor system is operated in the condition monitoring mode. For example, it is possible that the machine signal from the trigger sensor is analyzed as part of the preliminary analysis in order to check whether the machine is in operation. If the machine is in operation, the measuring step is carried out. For example, it is possible that it is checked whether the machine is in operation using computing means of the machine as part of the preliminary analysis. If the machine is in operation, the measuring step is carried out.

According to a preferred embodiment of the present disclosure, the learning data obtained in the learning mode is additionally used to determine one, some or all of the following parameters to be used in the condition monitoring mode, in particular in step b):
a duration for the measurement of the machine signal of the machine in the trigger step,
a sampling rate for the measurement of the machine signal of the machine in the trigger step,
a repetition rate or an interval or a time of day or a time of week for carrying out the trigger step, in particular for measuring the machine signal of the machine in the trigger step,
one or more parameters of the machine stabilization algorithm, in particular a duration of the waiting time. The one or more parameters are preferably determined using the learning data obtained in the learning mode in step a) and using statistical methods and/or machine learning and/or artificial intelligence. In this regard, not only the trigger threshold, but also other parameters for operating the sensor system in the condition monitoring mode can be determined or calculated on the basis of the learning data obtained in the learning mode.

According to an embodiment of the present disclosure, it is advantageously possible that the sensor system and/or the machine—preferably before and/or during operation of the sensor system in the learning mode—is provided with predefined values for one, some or all of the following parameters:
a duration for the measurement of the machine signal of the machine in the learning trigger step,
a sampling rate for the measurement of the machine signal of the machine in the learning trigger step,
a repetition rate or an interval or a time of day or a time of week for carrying out the learning trigger step, in particular for measuring the machine signal of the machine in the learning trigger step,
one or more parameters of the machine stabilization algorithm, in particular a duration of the waiting time period.
   The predefined values of the stated parameters can be used in the learning mode, in particular in step a).

According to a preferred embodiment of the present disclosure, during and/or after the measurement of the machine vibration and/or temperature signal by means of the vibration and/or temperature sensor in the measuring step, an acceptance test is carried out by means of an acceptance criterion for the measured machine vibration and/or temperature signal, wherein the measured machine vibration and/or temperature signal is only used to determine the machine condition if the acceptance criterion is fulfilled.

According to a preferred embodiment of the present disclosure, it is conceivable that the acceptance test is carried out by computing means of the vibration and/or temperature sensor, wherein the measured machine vibration and/or temperature signal is only transmitted from the vibration and/or temperature sensor and/or from the computing means of the vibration and/or temperature sensor to a gateway instance if the acceptance criterion is fulfilled. In particular, it is possible that the vibration and/or temperature sensor and/or the computing means of the vibration and/or temperature sensor do not transmit the measured machine vibration and/or temperature signal if the acceptance criterion is not fulfilled. This can be used to minimize the energy consumption of the communication means used to transmit the measured machine vibration and/or temperature signal from the vibration and/or temperature sensor to the gateway instance, as the transmission of unusable data or data with insufficient quality is avoided.

According to a preferred embodiment of the present disclosure, the acceptance criterion comprises an acceptance threshold value, wherein the acceptance test comprises monitoring whether the measured machine vibration and/or temperature signal, in particular during the measurement of the machine vibration and/or temperature signal, falls below the acceptance threshold value for a predefined number of consecutive samples of the measured machine vibration and/or temperature signal, wherein preferably the acceptance criterion is not fulfilled if the measured machine vibration and/or temperature signal falls below the acceptance threshold value for the predetermined number of consecutive sample values, wherein preferably the acceptance criterion is fulfilled if the measured machine vibration and/or temperature signal does not fall below the acceptance threshold value for the predetermined number of consecutive sample values during the duration of a measuring time interval. It is conceivable that the measuring time interval is a predefined measuring time interval. The measuring time interval can, for example, be chosen or selected by an operator and/or can depend on the machine and/or the operating conditions of the machine. For example, the measuring time interval can be in the order of seconds, such as three seconds or five seconds. Alternatively, it is conceivable that the duration of the measuring time interval is determined using the learning data obtained in the learning mode of the sensor system in step a). It is particularly preferred that if the measured machine vibration and/or temperature signal falls below the acceptance threshold value, the number of consecutive samples (for example, the number of consecutive individual measured values) of the machine vibration and/or temperature signal is counted for as long as the measured machine vibration and/or temperature signal remains below the acceptance threshold value and/or does not rise above the acceptance threshold value. It is conceivable that this counting of the consecutive sample values of the measured machine vibration and/or temperature signal is canceled and/or reset if the measured machine vibration and/or temperature signal rises above the acceptance threshold value. Preferably, if the measured machine vibration and/or temperature signal falls below the acceptance threshold value again, the counting of the consecutive samples is restarted from zero. If the number of consecutive samples reaches the predefined number of consecutive samples, the acceptance criterion is preferably not fulfilled. Preferably, the acceptance criterion is fulfilled if the number of consecutive samples does not reach the predefined number of consecutive samples.

According to a preferred embodiment of the present disclosure, it is conceivable that the measurement of the machine vibration and/or temperature signal by means of the vibration and/or temperature sensor is terminated in the measuring step:
in response to the vibration and/or temperature sensor receiving a further trigger signal, in particular from the further sensor and/or the computing device, wherein the further trigger signal indicates that the machine is not in the operating state and/or has transitioned from the operating state and/or that a stable working state of the machine is terminated; and
in response to the vibration and/or temperature sensor receiving a further trigger signal from the trigger sensor, wherein the further trigger signal indicates that the machine is not in the operating state and/or has transitioned from the operating state and/or that a stable working state of the machine is terminated; and/or
when a measuring time interval has elapsed; and/or
when a predefined total number of samples of the machine vibration and/or temperature signal has been received.

According to one embodiment of the present disclosure, it is particularly preferred that the learning mode is carried out in an initial learning phase of the sensor system after the sensor system has been installed on the machine. In this first learning phase, the sensor system works with preconfigured parameters that may or may not be specific to the machine type. As such, in the first learning phase, the vibration and/or temperature sensor measures the vibration and/or temperature signal of the machine with preconfigured parameters. During this initial learning phase, measurement data is obtained by the sensor system. This measurement data (or parts thereof) can be used as learning data for determining improved sensor parameters, in particular at least the improved and better adapted trigger threshold for the trigger sensor. During the initial learning phase, the sensor system sends time domain data, i.e., the measured signals, to the backend system, preferably more frequently than it would send data in its condition monitoring mode. During the initial learning phase, it is, for example, possible for the sensor system to send the time domain data, i.e., the measured signals, 4, 5, 6, 7 or 8 times per day. In contrast, in normal operation in the condition monitoring mode, the sensor system would only send data once a day, for example. Based on the data obtained in the initial learning phase (i.e., in the learning mode), the backend system calculates improved sensor-specific parameters using statistical methods, machine learning and/or artificial intelligence. These sensor-specific parameters can then be made available to the sensor system so that the sensor system can use these sensor-specific parameters in the condition monitoring mode. The sensor-specific parameters comprise at least the trigger threshold for the trigger sensor, but can also comprise further parameters used by the sensor system during its operation.

To achieve the above object, the disclosure further proposes a system for determining a machine condition, in particular for the condition monitoring of a machine, wherein the system comprises a sensor system, wherein the system optionally comprises the machine, wherein the sensor system can be attached to the machine or is contained in the machine, wherein the sensor system comprises:
a vibration and/or temperature sensor for measuring a machine vibration and/or a temperature of the machine, and
a trigger sensor;
   wherein the sensor system can be operated in a learning mode and in a condition monitoring mode,
   wherein the system is configured to carry out a method according to an embodiment of the present disclosure.

Preferably, the system according to the disclosure is a computer-implemented system comprising means for carrying out a method according to an embodiment of the present disclosure.

To achieve the above object, the disclosure further proposes a computer program comprising instructions which, when the computer program is executed by one or more computing means—in particular by a sensor system and/or a machine and/or a gateway unit and/or a backend system—cause the one or more computing means to execute a method according to an embodiment of the present disclosure.

For the system according to the disclosure and the computer program according to the disclosure, the same embodiments, advantages and technical effects can be achieved as described in connection with the method according to the disclosure, or in connection with an embodiment of the method according to the disclosure.

These and other features, properties and advantages of the present disclosure will become apparent from the following detailed description in conjunction with the accompanying drawings, which illustrate by way of example the principles of the disclosure. The description serves illustrative purposes only, without limiting the scope of the disclosure. The reference signs stated below refer to the accompanying drawings.

### BRIEF DESCRIPTION OF THE DRAWINGS

FIG. 1 shows an example for the operation of a machine not operating continuously;

FIG. 2 shows a system according to one embodiment of the present disclosure;

FIG. 3 shows a schematic representation of the operation of a sensor system in a learning mode for determining a trigger threshold according to one embodiment of the present disclosure;

FIG. 4 shows a schematic representation of a method according to one embodiment of the present disclosure;

FIG. 5 shows a vibration v over the time t of a machine for illustrating an embodiment of a method according to the present disclosure;

FIG. 6A shows a method according to one embodiment of the present disclosure in which the measured data do not pass an acceptance test;

FIG. 6B shows a method according to one embodiment of the present disclosure in which the measured data pass an acceptance test;

FIG. 7A and FIG. 7B show schematic representations of a comparison between the use of a trigger threshold determined by means of a learning mode according to one embodiment of the present disclosure (FIG. 7B) and the use of a conventional trigger threshold not determined in a learning mode (FIG. 7A).

### DETAILED DESCRIPTION

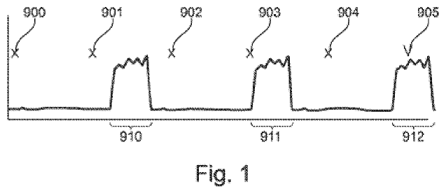

FIG. 1 shows an example for the operation of a machine not operating continuously in order to illustrate the disadvantages of the prior art. In the time intervals 910, 911, 912, the machine operates in such a way that a condition monitoring can be carried out. Outside of these time intervals, the machine is switched off or is in an operating state that is not suitable for condition monitoring. In the prior art, measurements for condition monitoring would be carried out at preconfigured points 900, 901, 902, 903, 904, 905, e.g., at regular intervals. However, the measurements at points 900, 901, 902, 903, 904 would be unsuitable for condition monitoring as they are carried out outside of the time intervals 910, 911, 912, so the overall result and quality of the condition monitoring would be insufficient. Such disadvantages can be overcome by the present disclosure.

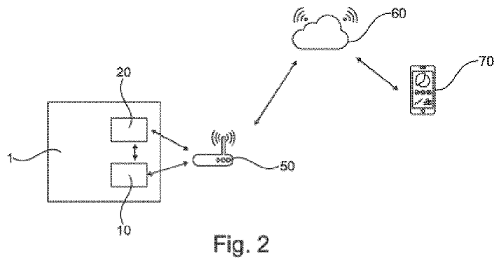

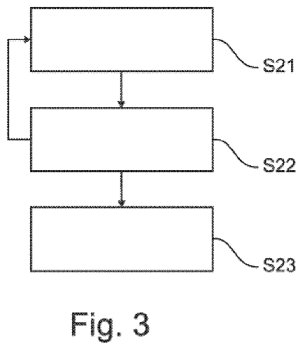

FIG. 2 shows a system according to one embodiment of the present disclosure. A vibration and/or temperature sensor 10 and a trigger sensor 20 are attached to or contained in a machine 1. Preferably, the vibration and/or temperature sensor 10 is at least one vibration sensor 10. However, in an alternative embodiment, the vibration and/or temperature sensor 10 is a temperature sensor. Preferably, the machine 1 is a machine 1 not operating continuously, for example a processing machine, an agricultural machine, a logistics machine, in particular a storage and retrieval unit, a transportation machine, in particular a subway or a railroad or a train or the like. The vibration sensor 10 and/or the trigger sensor 20 are preferably wireless devices used for the condition monitoring of the machine 1. The vibration sensor 10 and the trigger sensor 20 comprise an energy storage and/or energy harvesting device. According to one embodiment of the present disclosure, the trigger sensor 20 can be part of the vibration sensor 10. Preferably, the trigger sensor 20 and the vibration sensor 10 comprise MEMS for measuring vibrations of the machine 1. A gateway unit 50 is in communication with the trigger sensor 20 and/or the vibration sensor 10. It is conceivable that the gateway unit 50 is part of the computing device of the machine 1 or that the gateway unit is a separate gateway unit 50 from the machine 1. The sensors 10, 20 and/or the gateway entity 50 can form a mesh network or be part of a mesh network. It is conceivable that the gateway unit 50 communicates with a backend system and/or network 60, in particular a telecommunications network. Furthermore, it is possible that the system comprises a user device 70, for example a computer or a mobile device, which displays data and/or the condition of the machine. The respective devices of the system, in particular the vibration sensor 10, the trigger sensor 20 and/or the gateway unit 50, can have wireless communication means for communicating with one another and/or with the backend system and/or network 60. In particular, the sensor system comprising the vibration sensor 10 and the trigger sensor 20 can be operated in a learning mode in order to determine a trigger threshold for the trigger sensor 20 and in a condition monitoring mode in which the learned/determined trigger threshold is used. By means of the trigger sensor 20 and the vibration sensor 10, the steps a) and b) of a method according to the present disclosure can be carried out. Embodiments thereof are described, for example, in connection with FIGS. 3, 4, 5, 6A and 6B.

FIG. 3 shows a schematic representation of an embodiment of the operation of the sensor system in the learning mode for determining a trigger threshold for the trigger sensor 20 in step a) according to an embodiment of the present disclosure. Before step S21, a further predefined trigger threshold for the trigger sensor 20 is provided to the sensor system, in particular to the trigger sensor 20 or to the computing means connected to the trigger sensor 20, preferably before and/or during operation of the sensor system in the learning mode. In addition, further predefined parameters can be provided to the sensor system for operating the sensor system in the learning mode. Subsequently, a learning trigger step is carried out in step S21, wherein the trigger sensor 20 measures a machine signal of the machine 1. As part of step S21, a comparison between the machine signal and the predefined further trigger threshold is carried out, wherein, depending on the comparison between the machine signal and the predefined further trigger threshold, the vibration and/or temperature sensor 10 is transferred to the measuring state for carrying out a learning measuring step in step S22. In step 22, the learning measuring step is carried out, wherein the vibration and/or temperature sensor 10 measures a machine vibration and/or temperature signal of the machine 1 in order to obtain learning data. The learning data comprises, or is based on, the machine vibration and/or temperature signal measured in the learning measuring step. It is possible for the learning data to be transmitted to a backend system and/or network 60 for further evaluation. It is conceivable that steps S21 and S22 could be repeated in order to obtain further learning data. It is conceivable that steps S21 and S22 could be repeated one, a few or many times in order to obtain sufficient learning data. At some point, the method then transitions to step S23. In step S23, the learning data obtained is used to determine the trigger threshold for the trigger sensor 20. For example, the step S23 can be carried out by a backend system and/or network 60. However, it is also conceivable that the step S23 is carried out by computing means of the sensor system or a gateway unit or a computer located in the vicinity of the machine 1. In step S23, the trigger threshold for the trigger sensor 20 can be determined using statistical methods and/or machine learning and/or artificial intelligence. By determining the trigger threshold for the trigger sensor 20 using the learning data, an improved and more suitable trigger threshold can be determined that takes into account the local conditions and influences of the environment to which the machine or sensor system is exposed during operation. In this way, a more suitable and improved trigger threshold value can be achieved compared to simply using a predefined trigger threshold value. It is also possible that in step S23, using the learning data, further parameters for the operation of the sensor system in its condition monitoring mode can be determined by means of the statistical methods and/or machine learning and/or artificial intelligence. Such parameters can comprise, for example, one or more of the following parameters:
a duration for the measurement of the machine signal of the machine in the trigger step,
a sampling rate for the measurement of the machine signal of the machine in the trigger step,
a repetition rate or an interval or a time of day or a time of week for carrying out the trigger step, in particular for measuring the machine signal of the machine in the trigger step,
one or more parameters of the machine stabilization algorithm, in particular a duration of the waiting time period 301.

These parameters can also be better adapted to the individual local conditions of the machine 1 and the sensor system.

After step S23, the sensor system can be provided with the determined trigger threshold and optionally with one or more of the above-mentioned parameters. Subsequently, the step b) of a method according to the present disclosure is carried out.

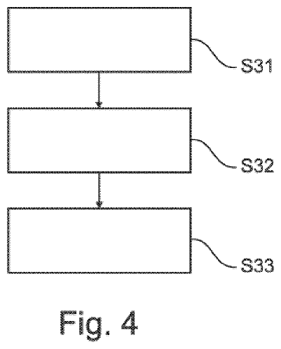

FIG. 4 shows a schematic representation of a method according to one embodiment of the present disclosure. In step S31, the sensor system is operated in the learning mode in order to determine a trigger threshold for the trigger sensor 20. For example, step S31 can comprise the steps S21, S22 and S23, as shown in FIG. 3. When the trigger threshold for the trigger sensor 20 has been determined, the sensor system is transferred to the condition monitoring mode and step S32 is carried out. Step S32 comprises operating the sensor system in the condition monitoring mode, wherein operating the sensor in the condition monitoring mode in step S32 comprises the following steps:
in a trigger step, the trigger sensor 20 measures a machine signal of the machine 1, wherein a comparison between the machine signal and the trigger threshold is carried out,
   wherein, depending on the comparison between the machine signal and the trigger threshold, the vibration and/or temperature sensor 10 is transferred to a measuring state for carrying out a measuring step.
in the measuring step, the vibration and/or temperature sensor 10 measures a machine vibration and/or temperature signal of the machine 1 in order to determine the machine condition. In step S33, an acceptance test 303 is carried out for the measured machine vibration and/or temperature signal by means of an acceptance criterion, wherein the measured machine vibration and/or temperature signal is only used to determine the condition of the machine 1 if the acceptance criterion is fulfilled.

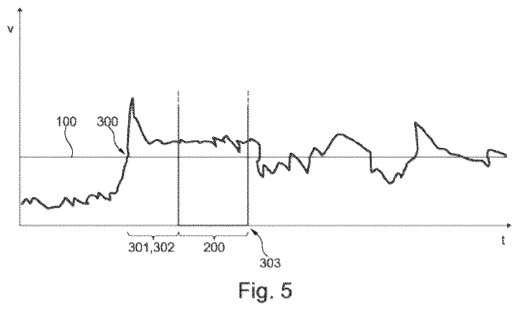

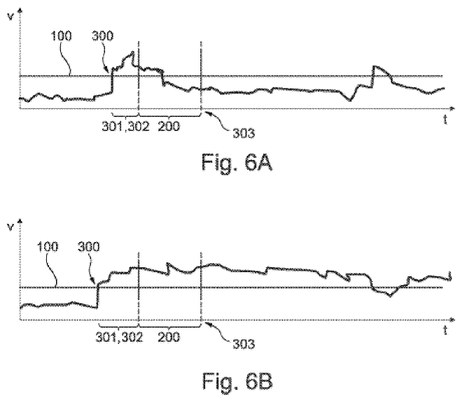

One embodiment of the acceptance test 303 is explained in more detail with reference to FIGS. 5, 6a and 6b.

FIG. 5 shows a vibration v over the time t of a machine 1 in order to illustrate one embodiment of a method according to the disclosure. In particular, an embodiment of step b) of a method according to the disclosure is shown, in which the sensor system is operated in a condition monitoring mode. When the trigger sensor 20 is in a trigger state, the trigger sensor 20 measures a machine signal of the machine 1, in particular a machine vibration. In the trigger state, the trigger sensor 20 measures the machine vibration at a comparatively low sampling rate, for example in the order of 10 Hz, in order to ensure low energy consumption. In the trigger step, a comparison between the measured machine signal and a trigger threshold is carried out so that an increase in the machine signal to and/or above the trigger threshold can be detected. The trigger threshold is a trigger threshold that was determined using the learning mode of the sensor system in step a). At a point in time 300, the trigger sensor 20 detects a vibration (i.e., a machine signal) that exceeds the trigger threshold. In response to this detection, the vibration sensor 10 is transferred from an idle or off state to a measuring state, for example by a command from the trigger sensor 20 or the gateway unit 50. It is possible that—before the vibration sensor 10 starts measuring the machine vibration signal of the machine 1 in order to determine the machine condition—a machine stabilization algorithm 302 is executed. The machine stabilization algorithm 302 can include allowing a waiting time 301 to elapse before the vibration sensor 10 transitions to the measuring state and/or before starting to measure the machine vibration signal using the vibration sensor 10. Alternatively or in addition, the machine stabilization algorithm 302 can comprise a preliminary analysis in order to check or verify that the machine 1 is in operation. For example, it is possible that the preliminary analysis comprises an analysis of the machine signal measured by the trigger sensor 20 in order to check or verify that the machine 1 is running. When the machine stabilization algorithm 302 has been run successfully, the measurement of the machine vibration signal by means of the vibration sensor 10 is carried out in the measuring step, in particular for a measuring time interval 200. In the measuring step, the vibration sensor measures 10 individual samples and/or measured values, which together form the machine vibration signal. During the measuring step and/or at the end of the measuring step, an acceptance test 303 can be carried out for the measured machine vibration signal. The acceptance test 303 can be used to ensure that the data obtained is of sufficient or desired quality. Preferably, the measured data, i.e., the measured machine vibration signal, is only transmitted from the vibration sensor 10 to the gateway unit 50 or to the backend system and/or the network 60 if the acceptance test is passed successfully. This enables a particularly energy-efficient method to be achieved. Preferably, the measured machine vibration signal is only used to determine the machine condition if the acceptance test 303 has been passed.

One embodiment of the acceptance test 303 is explained in more detail with reference to FIGS. 6A and 6B. The acceptance test 303 comprises an acceptance criterion, in particular an acceptance threshold value 100. It is possible that the acceptance threshold value 100 is the same value as the trigger threshold or corresponds to the trigger threshold. During the acceptance test, it is monitored whether the measured machine vibration signal falls below the acceptance threshold value 100 for a predetermined number of consecutive samples (in particular sample values) of the measured machine vibration signal, in particular during the measurement of the machine vibration signal. If the measured machine vibration signal falls below the acceptance threshold value 100, the number of consecutive sample values (for example, the number of consecutive individual measured values) of the vibration signal is counted for as long as the measured machine vibration signal remains below the acceptance threshold value 100. It is conceivable that this counting of the consecutive sample values of the measured machine vibration signal is canceled and/or reset if the measured machine vibration signal rises above the acceptance threshold value 100 again. Preferably, if the measured machine vibration signal falls below the acceptance threshold value 100 again, the counting of the consecutive samples is restarted from zero.

If the number of consecutive samples reaches the predefined number of consecutive samples, the acceptance criterion is not fulfilled and the acceptance test is not passed. This situation is shown in FIG. 6A.

However, if the number of consecutive samples does not reach the predefined number of consecutive samples, the acceptance criterion is fulfilled and the acceptance test is passed. This situation is shown in FIG. 6B. In this case, the measured vibration signal of the machine is used further to determine the condition of the machine 1.

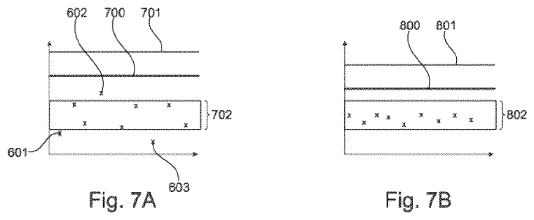

FIGS. 7A and 7B schematically illustrate a comparison between the use of a trigger threshold determined by means of a learning mode according to one embodiment of the present disclosure (FIG. 7B) and the use of a conventional trigger threshold not determined in the learning mode according to the present disclosure (FIG. 7A). When using a machine-specific trigger threshold, as shown in FIG. 7A, some of the measurements x are within a stable operating window 702 of the machine 1. However, some measured values 601, 602, 603 lie outside this window 702. As a result, the warning alarm threshold value 700 and a main alarm threshold value 701 for the machine must be selected such that they are further away from the stable operating window 702. This means that the achievable advance warning time is worse than the advance warning time that can be achieved with the present disclosure (FIG. 7B). In one embodiment of the present disclosure—as shown in FIG. 7B—it is possible that all or almost all measurements x are in the stable operating window 802, because an improved trigger threshold is used, which is determined by means of the learning mode according to the disclosure such that the measurements of the vibration and/or temperature sensor 20 are more frequently carried out in a stable operating state of the machine 1 suitable for condition monitoring. This allows the warning alarm threshold 800 and the main alarm threshold 801 for the machine to be set closer to the stable operating window 802, which can improve the advance warning time with respect to machine failure or wear. For example, in one embodiment of the present disclosure, as shown in FIG. 7B, an advance warning time in the order of months can be achieved. In contrast, only an advance warning time in the order of days or weeks can be achieved in FIG. 7A.

### LIST OF REFERENCE SIGNS

1 Machine
10 Vibration and/or temperature sensor
20 Trigger sensor
50 Gateway unit
60 Backend system and/or network
70 User device
100 Acceptance threshold value
200 Measuring time interval
300 Point
301 Waiting time
302 Machine stabilization algorithm
303 Acceptance test
601-603 Measurements
700 Warning alarm threshold
701 Main alarm threshold
702 Window for stable operation
800 Warning alarm threshold
801 Main alarm threshold
802 Window for stable operation
900-905 Points
910-912 Time intervals
S21-S23 Steps
S31-S33 Steps
t Time
V Vibration
x Measurements

1. A method for the condition monitoring of a machine,
wherein the machine comprises a sensor system,
wherein the sensor system comprises:
a vibration and/or temperature sensor for measuring a machine vibration and/or a temperature of the machine, and
a trigger sensor;
wherein the sensor system can be operated in a learning mode and in a condition monitoring mode,
wherein the method comprises the following steps:
a) operating the sensor system in the learning mode in order to determine a trigger threshold for the trigger sensor,
b) operating the sensor system in the condition monitoring mode, wherein operating the sensor system in the condition monitoring mode comprises the following steps:
in a trigger step, the trigger sensor measures a machine signal of the machine,
wherein a comparison between the machine signal and the trigger threshold is carried out,
wherein, depending on the comparison between the machine signal and the trigger threshold, the vibration and/or temperature sensor is transferred to a measuring state for carrying out a measuring step,
in the measuring step, the vibration and/or temperature sensor measures a machine vibration and/or temperature signal of the machine in order to determine the condition of the machine,
wherein the sensor system is provided with a predefined further trigger threshold for the trigger sensor, before and/or during operation of the sensor system in the learning mode,
wherein operating the sensor system in the learning mode in order to determine a trigger threshold for the trigger sensor comprises the following steps:
in a learning trigger step, the trigger sensor measures a machine signal of the machine,
wherein a comparison between the machine signal and the further trigger threshold is carried out,
wherein, depending on the comparison between the machine signal and the further trigger threshold, the vibration and/or temperature sensor is transferred to the measuring state for carrying out a learning measuring step,
in the learning measuring step, the vibration and/or temperature sensor measures a machine vibration and/or temperature signal of the machine in order to obtain the learning data,
wherein prior to operating the sensor system in the condition monitoring mode, the learning data obtained in the learning mode is used to determine the trigger threshold to be used in the condition monitoring mode of the sensor system in step b),
wherein the trigger threshold is used using the learning data obtained in the learning mode and using statistical methods and/or machine learning and/or artificial intelligence.

2. The method according to claim 1, wherein the trigger sensor is designed to measure a machine vibration of the machine,
wherein preferably the machine signal measured by the trigger sensor in the trigger step and/or in the learning trigger step is a trigger vibration signal of the machine; and
wherein the trigger sensor is designed to measure an electrical signal of the machine, namely an electrical current and/or a voltage,
wherein preferably the machine signal measured by the trigger sensor in the trigger step and/or in the learning trigger step is an electrical signal of the machine.

3. The method according to claim 1, wherein before the vibration and/or temperature sensor transitions to the measuring state and/or before the vibration and/or temperature sensor measures the machine vibration and/or temperature signal in the measuring step, a machine stabilization algorithm is carried out by means of computing means of the trigger sensor and/or computing means of a gateway unit and/or computing means of the machine,
wherein the machine stabilization algorithm comprises that:
a waiting time is allowed to elapse before the vibration and/or temperature sensor transitions to the measuring state and/or before the vibration and/or temperature sensor measures the machine vibration and/or temperature signal in the measuring step, and/or
a preliminary analysis is carried out in order to verify or check that the machine is in operation and/or to verify or check that the machine is in an operating state,
wherein preferably the vibration and/or temperature sensor transitions to the measuring state and/or starts measuring the machine vibration and/or temperature signal in the measuring step only after the waiting time has elapsed and/or only in the event that the preliminary analysis carried out shows that the machine is in operation and/or in an operating state.

4. The method according to claim 1, wherein the learning data obtained in the learning mode is additionally used to determine one, some or all of the following parameters to be used in the condition monitoring mode in step b):
a duration for the measurement of the machine signal of the machine in the trigger step,
a sampling rate for the measurement of the machine signal of the machine in the trigger step,
a repetition rate or an interval or a time of day or a time of week for carrying out the trigger step, namely for measuring the machine signal of the machine in the trigger step,
one or more parameters of the machine stabilization algorithm, at least a duration of the waiting time period.

5. The method according to claim 1, wherein during and/or after the measurement of the machine vibration and/or temperature signal by means of the vibration and/or temperature sensor in the measuring step, an acceptance test is carried out by means of an acceptance criterion for the measured machine vibration and/or temperature signal, wherein the measured machine vibration and/or temperature signal is only used to determine the condition of the machine if the acceptance criterion is fulfilled.

6. The method according to claim 5, wherein the acceptance criterion comprises an acceptance threshold value, wherein the acceptance test comprises monitoring whether the measured machine vibration and/or temperature signal, during the measurement of the machine vibration and/or temperature signal, falls below the acceptance threshold value for a predetermined number of consecutive samples of the measured machine vibration and/or temperature signal, wherein preferably the acceptance criterion is not fulfilled if the measured machine vibration and/or temperature signal falls below the acceptance threshold value for the predetermined number of consecutive sample values,
wherein preferably the acceptance criterion is fulfilled if the measured machine vibration and/or temperature signal does not fall below the acceptance threshold value for the predetermined number of consecutive sample values during the duration of a measuring time interval.

7. A system for the condition monitoring of a machine, wherein the system comprises a sensor system, wherein the system optionally comprises the machine, wherein the sensor system can be attached to the machine or is contained in the machine, wherein the sensor system comprises:
a vibration and/or temperature sensor for measuring a machine vibration and/or a temperature of the machine, and
a trigger sensor;
wherein the sensor system can be operated in a learning mode and in a condition monitoring mode,
wherein the system is configured to carry out a method according to claim 1.

8. A computer program comprising instructions which, when the computer program is executed by one or more computing means including a sensor system and/or a machine and/or a gateway unit and/or a backend system cause the one or more computing means to execute a method according to claim 1.

9. A method for the condition monitoring of a machine comprising:
operating a sensor system of a machine in a learning mode in order to determine a trigger threshold for a trigger sensor of the sensor system, wherein the sensor system includes at least one of a vibration sensor or a temperature sensor;
operating the sensor system in a condition monitoring mode of the sensor system, wherein operating the sensor system in the condition monitoring mode comprises the following steps:
measuring, with the trigger sensor, a machine signal of the machine, wherein a comparison between the machine signal and the trigger threshold is performed,
switching at least one of a vibration or temperature sensor to a measuring state for performing a measure step based on the comparison between the machine signal and the trigger threshold;
measuring, in the measuring step, at least one of a machine vibration or a temperature signal of the machine to determine the condition of the machine;
determining an additional trigger threshold for the trigger sensor in a learning trigger step for periods before or during operation of the sensor system comprising:
in the learning trigger step, measuring a machine signal of the machine with the trigger sensor;
comparing the machine signal and the additional trigger threshold;
switching at least one of the vibration sensor or the temperature sensor to the measuring state for performing a learning measuring step based on the comparison between the machine signal and the additional trigger threshold;
in the learning measuring step, measuring at least one of a machine vibration signal or a temperature signal of the machine with at least of the vibration sensor or the temperature sensor to obtain the learning data; and
determining, prior to operating the sensor system in the condition monitoring mode, the trigger threshold for use in the condition monitoring mode of the sensor system based on the learning date obtained in the learning mode.

10. The method according to claim 9, wherein the trigger sensor is configured to measure a machine vibration of the machine, wherein the machine signal measured by the trigger sensor in the trigger step and/or in the learning trigger step is a trigger vibration signal of the machine, wherein the trigger sensor is configured to measure an electrical signal of the machine, wherein the machine signal measured by the trigger sensor in the trigger step and/or in the learning trigger step is an electrical signal of the machine.

11. The method according claim 9, further comprising: performing a machine stabilization algorithm.

12. The method according to claim 9, wherein the learning data obtained in the learning mode is additionally used to determine one or more parameters for use in the condition monitoring mode.

13. The method according to claim 12, wherein the one or more parameters comprise at least one of:
a duration of the measurement of the machine signal of the machine in the trigger step;
a sampling rate for the measurement of the machine signal of the machine in the trigger step; or
a repetition rate or an interval or a selected time for carrying out the trigger step.

14. The method according to claim 9, further comprising: performing an acceptance test for the measured machine vibration and/or temperature signal, wherein the measured machine vibration and/or temperature signal is only used to determine the condition of the machine when an acceptance criterion is fulfilled.

15. The method according to claim 14, wherein the acceptance criterion comprises an acceptance threshold value, wherein the acceptance test comprises monitoring whether the measured machine vibration and/or temperature signal, during the measurement of the machine vibration and/or temperature signal, falls below the acceptance threshold value for a predetermined number of consecutive samples of the measured machine vibration and/or temperature signal, wherein the acceptance criterion is not fulfilled when the measured machine vibration and/or temperature signal falls below the acceptance threshold value for the predetermined number of consecutive sample values, wherein preferably the acceptance criterion is fulfilled when the measured machine vibration and/or temperature signal does not fall below the acceptance threshold value for the predetermined number of consecutive sample values during the duration of a measuring time interval.

16. A system for the condition monitoring of a machine comprising:
a sensor system, wherein the sensor system comprises:
at least one of a vibration sensor or temperature sensor for measuring at least one of machine vibration or a temperature of the machine; and
a trigger sensor,
wherein the sensor system is configured for operation in a learning mode and in a condition monitoring mode,
a controller, wherein the controller is configured to perform a set of program instructions, wherein the set of program instructions are configured to cause the controller to:
operate the sensor system of the machine in a learning mode to determine a trigger threshold for the trigger sensor of the sensor system;
operate the sensor system in a condition monitoring mode of the sensor system, wherein operating the sensor system in the condition monitoring mode comprises the following steps:
measure, with the trigger sensor, a machine signal of the machine, wherein a comparison between the machine signal and the trigger threshold is performed,
switch at least one of a vibration or temperature sensor to a measuring state for performing a measure step based on the comparison between the machine signal and the trigger threshold;
measure, in the measuring step, at least one of a machine vibration or a temperature signal of the machine to determine the condition of the machine; and
determine an additional trigger threshold for the trigger sensor in a learning trigger step for periods before or during operation of the sensor system.

17. The system according to claim 16, wherein the determining an additional trigger threshold for the trigger sensor in the learning trigger step for periods before or during operation of the sensor system comprises:
in the learning trigger step, measuring a machine signal of the machine with the trigger sensor;
comparing the machine signal and the additional trigger threshold;
switching at least one of the vibration sensor or the temperature sensor to the measuring state for performing a learning measuring step based on the comparison between the machine signal and the additional trigger threshold;
in the learning measuring step, measuring at least one of a machine vibration signal or a temperature signal of the machine with at least of the vibration sensor or the temperature sensor to obtain the learning data; and
determining, prior to operating the sensor system in the condition monitoring mode, the trigger threshold for use in the condition monitoring mode of the sensor system based on the learning date obtained in the learning mode.

18. The system according to claim 16, wherein the trigger sensor is configured to measure a machine vibration of the machine, wherein the machine signal measured by the trigger sensor in the trigger step and/or in the learning trigger step is a trigger vibration signal of the machine, wherein the trigger sensor is configured to measure an electrical signal of the machine, wherein the machine signal measured by the trigger sensor in the trigger step and/or in the learning trigger step is an electrical signal of the machine.

19. The system according claim 17, further comprising: performing a machine stabilization algorithm.

20. The system according to claim 17, wherein the learning data obtained in the learning mode is additionally used to determine one or more parameters for use in the condition monitoring mode.
